(19) United States
(12) Patent Application Publication
(10) Pub. No.: US 2013/0003036 A1
(43) Pub. Date: Jan. 3, 2013

(54) PHOTO MASK UNIT COMPRISING A PHOTOMASK AND A PELLICLE AND A METHOD FOR MANUFACTURING THE SAME

(75) Inventors: Shoji Akiyama, Gunma (JP); Yoshihiro Kubota, Gunma (JP)

(73) Assignee: SHIN-ETSU CHEMICAL CO., LTD., Tokyo (JP)

(21) Appl. No.: 13/608,716

(22) Filed: Sep. 10, 2012

(30) Foreign Application Priority Data
Apr. 2, 2010 (JP) 2010-086368
Oct. 3, 2011 (JP) PCT/JP2011/055602

(51) Int. Cl. G03B 27/58; B23P 11/00

(52) U.S. Cl. 355/72; 29/428

(57) ABSTRACT

It is an object of the present invention to provide a photomask unit suitable for forming a microscopic pattern of 32 nm or smaller on a photoresist film using the EUV exposure technique and being able to reliably prevent the flatness of a photomask from being lowered. The photomask unit 1 according to the present invention includes a pellicle membrane 6, a pellicle frame 7 onto one surface of which a region of the pellicle membrane 6 in the vicinity of side portions of the pellicle membrane 6 is fixed, a photomask 2 and a stage 3 onto one surface of which the photomask 2 and the pellicle frame 7 are fixed, and the pellicle frame 7 is fixed onto the stage 3 at a region outside of a region of the stage 3 onto which the photomask 2 is fixed.

### CROSS-REFERENCES TO RELATED APPLICATIONS

This application is a continuation-in-part of and claims priority to International Patent Application No. PCT/JP2011/055602 filed on Oct. 3, 2011 and is related to and claims priority to Japanese Patent Application No. JP2010-086368 filed on Apr. 2, 2010, the entire content of both patent applications is hereby incorporated by reference.

### FIELD OF THE INVENTION

The present invention relates to a method for fabricating a photomask unit comprising a pellicle for lithography for use as a dustproof cover for an exposure stencil such as a photomask, a reticle or the like (hereinafter collectively referred to as “photomask” in this specification) when a semiconductor device such as a large-scale integrated circuit, a very-large-scale integrated circuit (LSI) or the like, or a liquid crystal display panel is to be manufactured and a photomask, and particularly relates to a photomask unit and a method for fabricating a photomask unit suitable for exposing a photoresist film to light having an extremely short wavelength, thereby forming a microscopic pattern.

### BACKGROUND OF THE INVENTION

In the case of manufacturing a semiconductor device such as a large-scale integrated circuit (LSI), a very-large-scale integrated circuit or the like, or a liquid crystal display panel, a photoresist film formed on a semiconductor wafer or a liquid crystal display panel mother substrate is irradiated with an exposure light via a photomask, whereby a pattern of the photomask is transferred onto the semiconductor device or the liquid crystal display panel mother substrate so that a pattern of the semiconductor device or the liquid crystal display panel is formed.

Therefore, in this case, when any foreign materials such as dust particles stuck to the photomask, reflect or absorb the an exposure light, so that not only does the pattern transferred onto the semiconductor wafer or the liquid crystal display panel mother substrate become deformed and the edge portion of the pattern become blurred but underlying surface is also blackened by soiling, whereby the size, quality, appearance and the like of the semiconductor wafer or the liquid crystal display panel mother substrate are degraded so that the pattern of the photomask cannot be transferred onto the semiconductor wafer or the liquid crystal display panel mother substrate in the desired manner. As a result, the performance of the semiconductor wafer or the liquid crystal display panel mother substrate is lowered, whereby the yield ratio of the semiconductor wafer or the liquid crystal display panel mother substrate is inevitably reduced.

In order to solve these problems, the operation of exposing the semiconductor wafer or the liquid crystal display panel mother substrate is generally conducted in a clean room. However, even in such a case, since it is extremely difficult to completely prevent foreign materials from attaching to the surface of the photomask, the operation of exposing the semiconductor wafer or the liquid crystal display panel mother substrate is usually conducted with a dust proof cover, called a pellicle, and having a high transmittance with respect to the exposure light, mounted on the surface of the photomask.

Generally, a pellicle is manufactured by adhering a pellicle membrane made of a material having a high transmittance with respect to an exposure light, such as a cellulose based resin like nitrocellulose or cellulose acetate, fluoride resin or the like, to one surface of a pellicle frame made of aluminum, stainless steel, polyethylene or the like by applying a good solvent for the material of the pellicle membrane onto the one surface of the pellicle frame and adhering the air-dried pellicle membrane onto the one surface of the pellicle frame, or adhering the pellicle membrane onto the one surface of the pellicle frame using an adhesive agent such as acrylic resin, epoxy resin, fluorine resin or the like, and then forming an agglutinant layer composed of polybutene resin, polyvinyl acetate resin, acrylic resin, silicone resin or the like and adapted for adhering the photomask, and providing a release layer or a separator for protecting the agglutinant layer on the agglutinant layer (See Japanese Patent Application Laid Open No. 58-219023, U.S. Pat. No. 4,861,402, Japanese Patent Publication No. 63-27707 and Japanese Patent Application Laid Open No. 7-168345, for example).

In the case of mounting the thus constituted pellicle on the surface of the photomask and exposing the semiconductor wafer or the liquid crystal display panel mother substrate via the photomask, since foreign materials such as dust particles attach to the surface of the pellicle and do not directly attach to the surface of the photomask, it is possible to avoid the effect of foreign materials such as dust particles by projecting an exposure light in such a manner that the light is focused on the pattern formed on the photomask.

FIG. 1 is a schematic plan view showing a conventional photomask unit including a photomask and a pellicle attached to the photomask and FIG. 2 is a schematic cross sectional view taken along a line A-A in FIG. 1.

As shown in FIGS. 1 and 2, a photomask unit 1 includes a photomask 2 and a pellicle 5 including a pellicle membrane 6 and a frame-like shaped pellicle frame 7 wherein a region of the pellicle membrane 6 in the vicinity of side portions thereof is adhered to the one surface of the pellicle frame 7 and the other surface of the pellicle frame 7 is fixed onto the surface of the photomask 2 by an agglutinant agent (not shown) comprising an organic material.

In this manner, since the surface of the photomask 2 is covered by a pellicle 5 as a dustproof cover, when the photoresist film formed on a semiconductor wafer or a liquid crystal display panel mother substrate is to be exposed, foreign materials such as dusts are attached onto the surface of the pellicle membrane 6 but the foreign materials are not directly attached onto the surface of the photomask 2. Therefore, if an exposure light is projected onto the photomask 2 in such a manner that the exposure light is focused onto a pattern formed on the photomask 2, it is possible to eliminate affection of the foreign materials such as dusts.

On the other hand, a semiconductor device and a liquid crystal display panel are recently required to have higher integration density and a more microscopic pattern and at present, it is put into practical use to form a microscopic pattern of about 45 nm on a photoresist film. It is possible to form a microscopic pattern of about 45 nm on a photoresist film by improving a conventional exposure technique using an eximer laser beam, for example, an immersion exposure technique including steps of filling a space between the semiconductor wafer or the liquid crystal display panel mother substrate and a projector lens with liquid such as ultrapure water and exposing the photoresist film to an argon fluoride (ArF) excimer laser beam, a double exposure technique or the like.

However, it is required for a next-generation type semiconductor device or a next-generation type liquid crystal display panel to form a more microscopic pattern of 32 nm or smaller on a photoresist film and it is impossible to form a microscopic pattern of 32 nm or smaller on a photoresist film by improving a conventional exposure technique using an excimer laser beam. Thus, an EUV (Extreme Ultra Violet) exposure technique using an EUV (Extreme Ultra Violet) light whose dominant wavelength is 13.5 nm is considered a strong favorite as a method for forming a pattern of 32 nm or smaller.

In the case of forming a microscopic pattern of 32 nm or smaller on a photoresist film using the EUV exposure technique, it is necessary to solve technical problems of what light source is to be employed, what photoresist is to be employed, what pellicle is to be employed and the like.

Among these problems, the development of a new light source and that of a new photoresist material have been advanced and a various proposals have been made. To the contrary, in connection with a pellicle which determines a yield ratio of a semiconductor device or a liquid crystal display panel, although silicon is proposed as a material having a high transmittance with respect to an EUV light, a various problems are left unsolved and what pellicle is to be employed remains a major obstacle to put the EUV exposure method into practical use. (See Shroff et al. “EUV pellicle Development for Mask Defect Control,” Emerging Lithographic Technologies X, Proc of SPIE Vol. 6151 615104-1 (2006), U.S. Pat. No. 6,623,893 B1 and the like.)

### SUMMARY OF THE INVENTION

In the case of forming a pattern on a photoresist film by exposing the photoresist film to an i ray (wavelength: 365 nm), a krypton fluoride (KrF) excimer laser beam (wavelength: 248 nm) or an argon fluoride (ArF) excimer laser beam (wavelength: 193 nm), a pellicle frame to which a pellicle membrane is attached is mounted on a photomask via an agglutinant agent containing an organic material. However, in the case of forming a microscopic pattern of 32 nm or smaller on a photoresist film using an EUV exposure technique, it is necessary to keep an exposure chamber to be vacuum. As a result, in the case of employing an agglutinant agent containing an organic material, since an outgas is generated from the agglutinant agent containing the organic material, it is difficult to mount a pellicle frame on a photomask using an agglutinant agent containing an organic material and it is necessary to avoid as practicably as possible using an agglutinant agent containing an organic material in the vicinity of a photomask.

Further, in order to form a microscopic pattern on the photoresist film using the EUV exposure technique, a photomask is required to have a high flatness but in the case of mounting a pellicle frame on a photomask using an agglutinant agent containing an organic material, the flatness of a photomask is lowered.

It is therefore an object of the present invention to provide a photomask unit comprising a pellicle and a photomask, the photomask unit being suitable for forming a microscopic pattern of 32 nm or smaller on a photoresist film using an EUV exposure technique and being able to reliably prevent the flatness of a photomask from being lowered.

Another object of the present invention is to provide a method for fabricating a photomask unit comprising a pellicle and a photomask, the photomask unit being suitable for forming a microscopic pattern of 32 nm or smaller on a photoresist film using an EUV exposure technique and being able to reliably prevent the flatness of a photomask from being lowered.

The above objects of the present invention can be accomplished by a photomask unit comprising a pellicle membrane, a pellicle frame having a frame-like shape onto one surface of which a region of the pellicle membrane in the vicinity of side portions of the pellicle membrane is attached, a photomask, and a stage onto one surface of which the photomask and the pellicle frame are fixed, wherein the pellicle frame is fixed onto the stage at a region outside of a region of the stage onto which the photomask is fixed.

According to the present invention, since the pellicle frame onto the one surface of which the region of the pellicle membrane in the vicinity of side portions of the pellicle membrane is attached is fixed onto the stage at a region outside of a region of the stage onto which the photomask is fixed and the region of the stage onto which the pellicle frame is fixed is apart from an exposure pattern portion of the photomask where the photomask formed with a pattern and exposed to light is located, when a microscopic pattern of 32 nm or smaller is formed on a photoresist film using the EUV exposure technique while keeping an exposure chamber to be vacuum, even if an outgas is generated from the agglutinant agent containing an organic material, it is possible to efficiently prevent the exposure operation of the photoresist film formed on a semiconductor device or the liquid crystal display panel from being subject to adverse effect.

Further, according to the present invention, since the pellicle frame is fixed onto the stage at a region outside of a region of the stage onto which the photomask is fixed and is not fixed onto the photomask unlike the conventional photomask unit, it is possible to reliably prevent the flatness of the photomask from being lowered.

In the present invention, it is preferable for the pellicle frame to be made of metal.

In a preferred aspect of the present invention, the pellicle frame is fixed by an electrostatic chuck onto the one surface of the stage.

According to this preferred aspect of the present invention, since the pellicle frame is fixed by an electrostatic chuck onto the one surface of the stage, it is possible to reliably prevent an outgas from being generated from a portion where the pellicle frame is fixed on the stage, when a microscopic pattern of 32 nm or smaller is formed on a photoresist film using the EUV exposure technique while keeping an exposure chamber to be vacuum.

In another preferred aspect of the present invention, the pellicle frame is fixed by a mechanical means onto the one surface of the stage.

According to this preferred aspect of the present invention, the pellicle frame is fixed by a mechanical means such as clamps, threads or the like onto the one surface of the stage, it is possible to reliably prevent an outgas from being generated from a portion where the pellicle frame is fixed on the stage, when a microscopic pattern of 32 nm or smaller is formed on a photoresist film using the EUV exposure technique while keeping an exposure chamber to be vacuum.

In another preferred aspect of the present invention, the pellicle frame is fixed by an agglutinant agent onto the one surface of the stage.

The above objects of the present invention can be also accomplished by a method for fabricating a photomask unit comprising a pellicle membrane, a pellicle frame having a frame-like shape and onto the one surface of which a region of the pellicle membrane in the vicinity of side portions of the pellicle membrane is attached, a photomask and a stage onto the one surface of which the photomask and the pellicle frame are to be fixed, the method for fabricating a photomask unit comprising steps of fixing the photomask onto the one surface of the stage and fixing the other surface of the pellicle frame onto the one surface of the stage at a region outside of a region of the one surface of the stage onto which the photomask is fixed.

According to the present invention, since the pellicle frame onto the one surface of which the region of the pellicle membrane in the vicinity of side portions of the pellicle membrane is attached is fixed onto the stage at a region outside of a portion of the stage onto which the photomask is fixed and the portion of the stage onto which the pellicle frame is fixed is apart from an exposure pattern portion of the photomask where the photomask formed with a pattern and exposed to light is located, when a microscopic pattern of 32 nm or smaller is formed on a photoresist film using the EUV exposure technique while keeping an exposure chamber to be vacuum, even if an outgas is generated from the agglutinant agent containing an organic material, it is possible to efficiently prevent the exposure operation of the photoresist film formed on a semiconductor device or a liquid crystal display panel from being subject to adverse effect.

Further, according to the present invention, since the pellicle frame is fixed onto the stage at a region outside of a region of the stage onto which the photomask is fixed and is not fixed onto the photomask unlike the conventional photomask unit, it is possible to reliably prevent the flatness of the photomask from being lowered.

In a preferred aspect of the present invention, the pellicle frame is fixed by an electrostatic chuck onto the one surface of the stage.

According to this preferred aspect of the present invention, the pellicle frame is fixed by an electrostatic chuck onto the one surface of the stage, it is possible to reliably prevent an outgas from being generated from a portion where the pellicle frame is fixed onto the stage, when a microscopic pattern of 32 nm or smaller is formed on a photoresist film using the EUV exposure technique while keeping an exposure chamber to be vacuum.

In another preferred aspect of the present invention, the pellicle frame is fixed by a mechanical means onto the one surface of the stage.

According to this preferred aspect of the present invention, the pellicle frame is fixed by a mechanical means such as a clamp, a thread or the like onto the one surface of the stage, it is possible to reliably prevent an outgas from being generated from a portion where the pellicle frame is fixed onto the stage, when a microscopic pattern of 32 nm or smaller is formed on a photoresist film using the EUV exposure technique while keeping an exposure chamber to be vacuum.

In another preferred aspect of the present invention, the pellicle frame is fixed by an agglutinant agent onto the one surface of the stage.

The above and other objects and features of the present invention will become apparent from the following description made with reference to the accompanying drawings.

According to the present invention, it is possible to provide a photomask unit comprising a photomask and a pellicle, the photomask unit being suitable for forming a microscopic pattern of 32 nm or smaller on a photoresist film using an EUV exposure technique and being able to reliably prevent the flatness of a photomask from being lowered.

Further, according to the present invention, it is possible to provide a method for fabricating a photomask unit comprising a photomask and a pellicle, the photomask unit being suitable for forming a microscopic pattern of 32 nm or smaller on a photoresist film using an EUV exposure technique and being able to reliably prevent the flatness of a photomask from being lowered.

### BRIEF DESCRIPTION OF THE DRAWINGS

FIG. 1 is a schematic plan view showing a conventional photomask unit including a photomask and a pellicle attached onto the photomask.

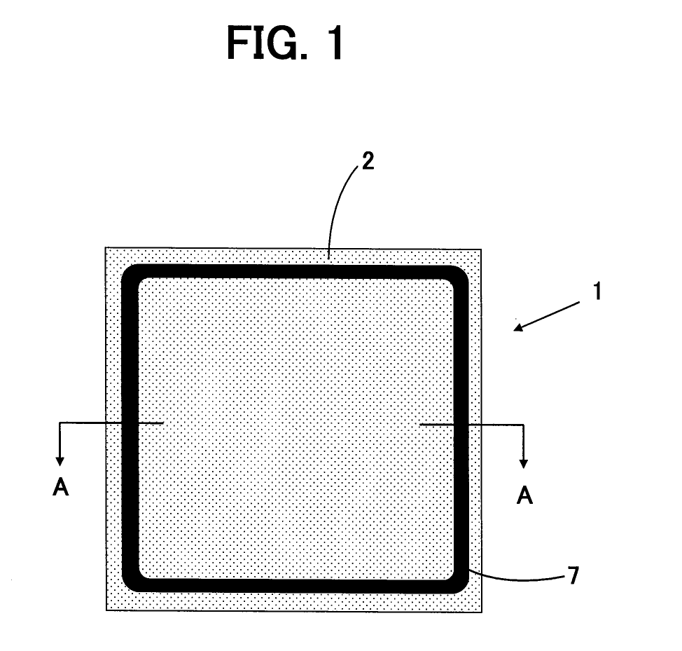

FIG. 2 is a schematic cross sectional view taken along a line A-A in FIG. 1.

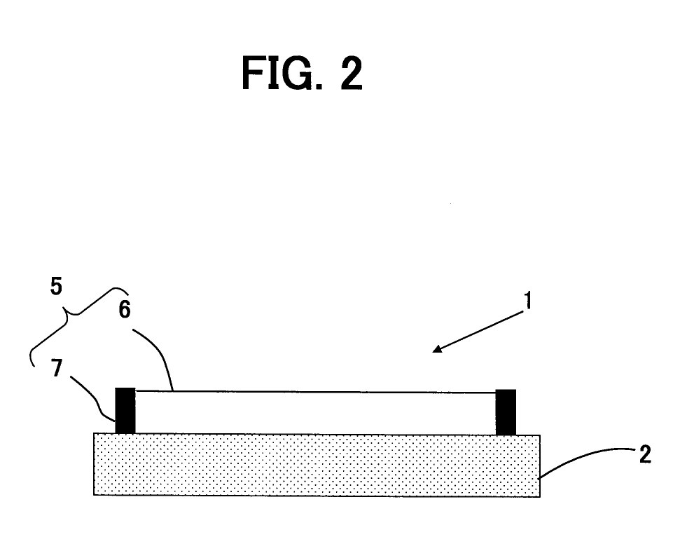

FIG. 3 is a schematic perspective plan view showing a photomask unit including a photomask and a pellicle covering the photomask, which is a preferred embodiment of the present invention.

FIG. 4 is a schematic cross sectional view taken along a line B-B in FIG. 3.

FIG. 5 is a schematic perspective plan view showing a photomask unit including a photomask and a pellicle, wherein the pellicle is attached onto the photomask stage, which is another preferred embodiment of the present invention.

FIG. 6 is a schematic cross sectional view taken along a line C-C in FIG. 5.

### DETAILED DESCRIPTION OF THE PREFERRED EMBODIMENTS

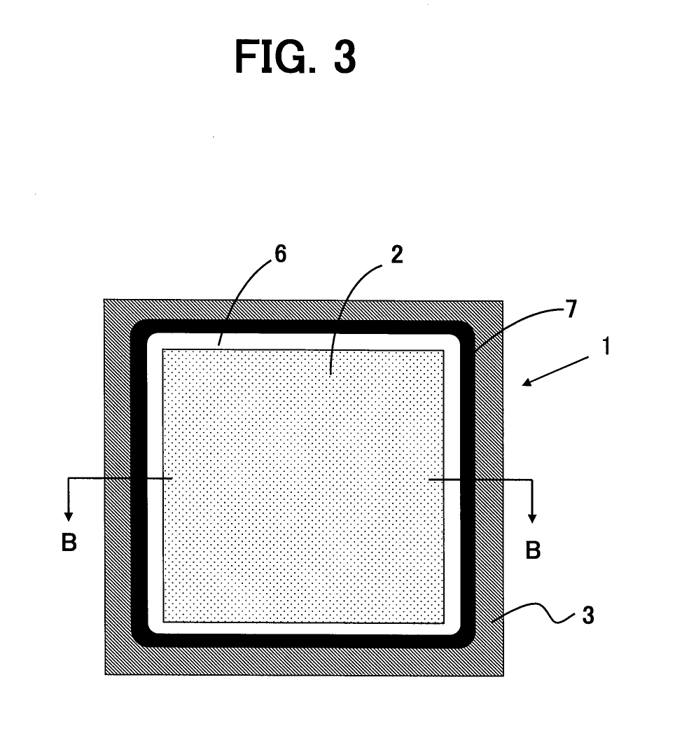

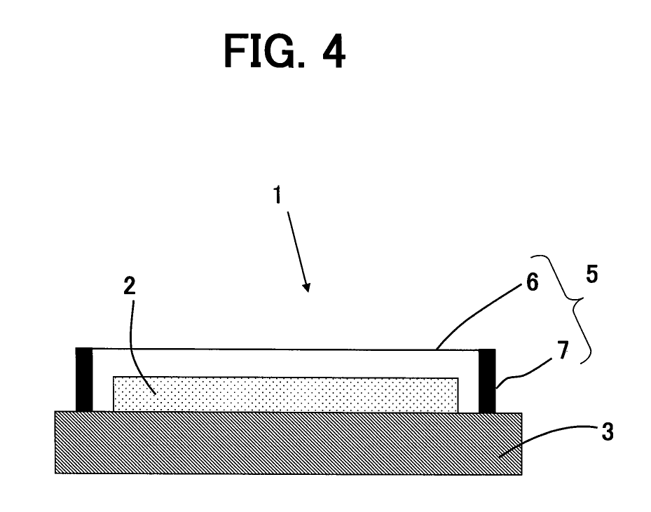

FIG. 3 is a schematic perspective plan view showing a photomask unit including a photomask and a pellicle covering the photomask, which is a preferred embodiment of the present invention and FIG. 4 is a schematic cross sectional view taken along a line B-B in FIG. 3.

As shown in FIGS. 3 and 4, a photomask unit 1 according to this preferred embodiment includes a photomask 2, a photomask stage 3 onto which the photomask 2 is to be fixed, a pellicle membrane 6 and a pellicle frame 7 having a frame-like shape and attached with the pellicle membrane 6 on the one surface thereof, and a pellicle 5 is constituted by the pellicle membrane 6 and the pellicle frame 7. In this embodiment, the pellicle frame 7 is made of aluminum.

As shown in FIGS. 3 and 4, the size of the pellicle frame 7 is larger than that of the photomask 2 and the pellicle frame 7 is fixed onto the photomask stage 3 at a region outside of a region of the photomask stage 3 onto which the photomask 2 is fixed. Thus, the photomask 2 is accommodated in a closed space defined by the pellicle membrane 6 and the pellicle frame 7.

In this embodiment, the photomask 2 is fixed by an electrostatic chuck (not shown) onto the photomask stage 3.

On the other hand, in this preferred embodiment, although the pellicle frame 7 is also fixed by an electrostatic chuck onto the photomask stage 3, the pellicle frame 7 may be fixed onto the photomask stage 3 using a mechanical means such as a clamp, a thread or the like. Further, the pellicle frame 7 may be fixed onto the photomask stage 3 using an agglutinant agent containing an organic material such as a silicone agglutinant agent.

The thus fabricated photomask unit 1 is set in an exposure chamber (not shown). Then, an exposure light is projected via the photomask 2 onto a photoresist film coated on a semiconductor wafer or a liquid crystal display panel mother substrate and a pattern of the photomask 2 is transferred onto the photoresist film, thereby forming a pattern of a semiconductor wafer or the liquid crystal display panel mother substrate.

In this preferred embodiment, the photomask 2 and the pellicle frame 7 are fixed onto the photomask stage 3 by the electrostatic chuck and the size of the pellicle frame 7 is larger than that of the photomask 2. Thus, the pellicle frame 7 is fixed by an electrostatic chuck onto the photomask stage 3 at a region outside of a region of the photomask stage 3 onto which the photomask 2 is fixed. Therefore, even when the photoresist film of the semiconductor wafer or the liquid crystal display panel mother substrate (not shown) is exposed to an EUV light while keeping an exposure chamber to be vacuum, an outgas cannot be generated. Accordingly, even in the case of forming a microscopic pattern of 32 nm or smaller on the photoresist film while keeping an exposure chamber to be vacuum, it is possible to improve the yield ratio of the semiconductor device or the liquid crystal display panel.

Further, according to this preferred embodiment, since the pellicle frame 7 is fixed onto the photomask stage 3 at a region outside of a region of the photomask stage 3 onto which the photomask 2 is fixed and is not fixed onto the surface of the photomask 2 unlike the conventional photomask unit, it is possible to suppress the lowering of the flatness of the photomask 2 caused by attaching the pellicle 5 to the minimum.

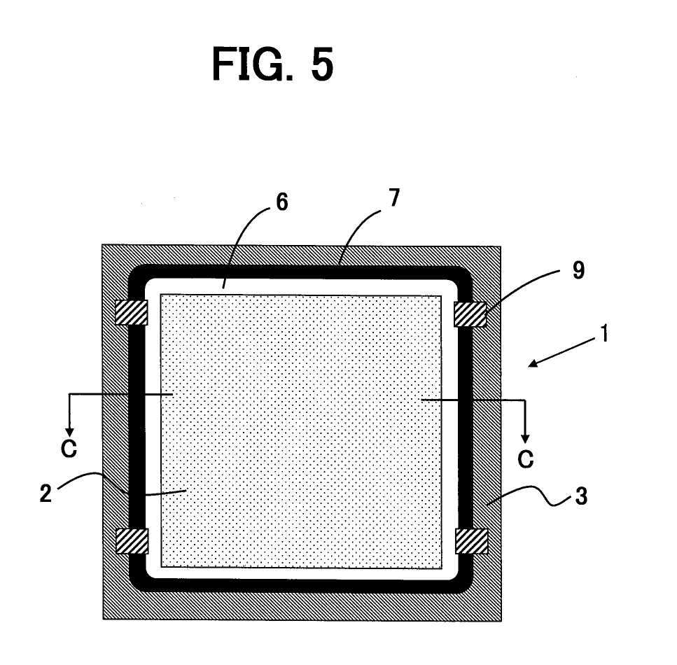

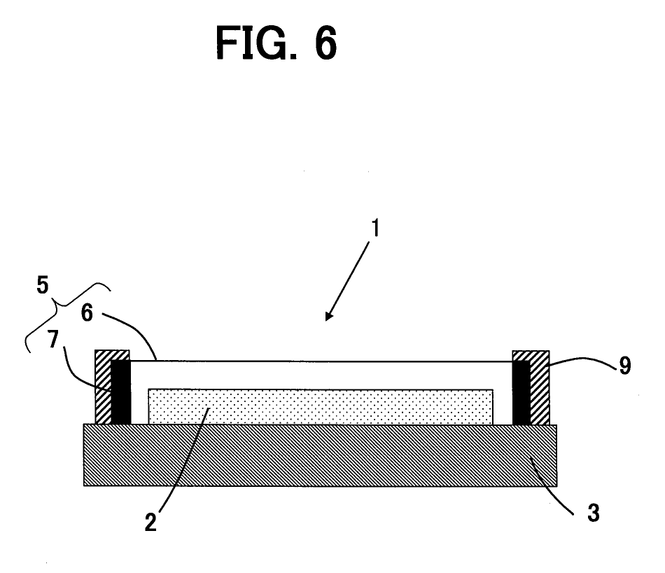

FIG. 5 is a schematic perspective plan view showing a photomask unit including a photomask and a pellicle attached to the photomask stage, which is another preferred embodiment of the present invention and FIG. 6 is a schematic cross sectional view taken along a line C-C in FIG. 5.

As shown in FIGS. 5 and 6, similarly to the photomask unit 1 according to the previous embodiment, a photomask unit 1 according to this preferred embodiment includes a photomask 2, a photomask stage 3 onto the one surface of which the photomask 2 is to be fixed, a pellicle membrane 6 and a frame-like shaped pellicle frame 7 onto which the pellicle membrane 6 is attached, and a pellicle 5 is constituted by the pellicle membrane 6 and the pellicle frame 7. In this embodiment, the pellicle frame 7 is also made of aluminum.

As shown in FIGS. 5 and 6, the size of the pellicle frame 7 is larger than that of the photomask 2 and the pellicle frame 7 is fixed onto the photomask stage 3 at a region outside of a region of the photomask stage 3 onto which the photomask 2 is fixed.

Like the previous embodiment, in this embodiment of the present invention, the photomask 2 is fixed by an electrostatic chuck onto the photomask stage 3.

In the photomask unit 1 according to this preferred embodiment, as shown in FIGS. 5 and 6, the pellicle frame 7 is fixed onto the photomask stage 3 by a mechanical clamp 9.

The thus fabricated photomask unit 1 is set in an exposure chamber (not shown). Then, an exposure light is projected via the photomask 2 onto a photoresist film formed on a semiconductor wafer or a liquid crystal display panel mother substrate and a pattern of the photomask 2 is transferred onto the photoresist film, thereby forming a pattern of a semiconductor wafer or a liquid crystal display panel mother substrate.

In this preferred embodiment, the size of the pellicle frame 7 is larger than that of the photomask 2 and the pellicle frame 7 is fixed by mechanical clamp 9 onto the photomask stage 3 at a region outside of a region of the photomask stage 3 onto which the photomask 2 is fixed. Therefore, even when the photoresist film of the semiconductor wafer or the liquid crystal display panel mother substrate (not shown) is exposed to an EUV light while keeping an exposure chamber to be vacuum, an outgas cannot be generated. Thus, even in the case of forming a microscopic pattern of 32 nm or smaller while keeping an exposure chamber to be vacuum, it is possible to improve the yield ratio of the semiconductor device or the liquid crystal display panel.

Further, according to this preferred embodiment, since the pellicle frame 7 is fixed onto the photomask stage 3 at a region outside of a region onto which the photomask 2 is fixed and is not fixed onto the surface of the photomask 2 unlike the conventional photomask unit, it is possible to suppress the lowering of the flatness of the photomask 2 caused by attaching the pellicle 5 to the minimum.

Hereinafter, working examples and a comparative example will be set out in order to further clarify the advantages of the present invention.

### WORKING EXAMPLE NO. 1

A square shaped photomask substrate whose one side length was 152 mm and thickness was 6 mm and which was made of quartz was prepared and a chromium film was evaporated on one surface of the photomask substrate and the other surface of the photomask substrate was fixed onto a photomask stage by an electrostatic chuck.

Then, a rectangle shaped pellicle frame whose inner frame length was 160 mm, outer frame length was 166 mm and wall thickness was 3 mm and which was made of aluminum was prepared and the pellicle frame was fixed by an electrostatic chuck onto the photomask stage at a region outside of a region of the photomask stage onto which the photomask substrate was fixed, thereby fabricating a photomask unit.

Next, in order to simulate the behavior of the photomask unit when it would be subjected to a high speed scanning operation in an actual manufacturing line, the photomask stage was vibrated for ten minutes so that acceleration of about 5 G was applied to the photomask stage. As a result, the displacement of the pellicle frame from its initial position was not observed although the pellicle frame was fixed onto the photomask stage only by the electrostatic chuck.

Further, an EUV light having a wavelength of 13.5 nm was intermittently projected onto the photomask unit for three minutes in total and the reflection ratio of the photomask was measured after the irradiation with the EUV light. The thus measured reflection ratio of the photomask was compared with the reflection ratio of the photomask before the irradiation with the EUV light. As a result, the reduction in reflection ratio of the photomask was not observed.

### WORKING EXAMPLE NO. 2

A square shaped photomask substrate whose one side length was 152 mm and thickness was 6 mm and which was made of quartz was prepared and a chromium film was evaporated on the one surface of the photomask substrate and the other surface of the photomask substrate was fixed onto a photomask stage by an electrostatic chuck.

Then, a pellicle frame made of aluminum whose inner frame length was 160 mm, outer frame length was 166 mm and wall thickness was 3 mm was prepared and the pellicle frame was fixed by a mechanical clamp onto the photomask stage at a region outside of a region of the photomask stage onto which the photomask substrate was fixed, thereby fabricating a photomask unit.

Next, in order to simulate the behavior of the photomask unit when it would be subjected to a high speed scanning operation in an actual manufacturing line, the photomask stage was vibrated for ten minutes so that acceleration of about 5 G was applied to the photomask stage. As a result, the displacement of the pellicle frame from its initial position was not observed although the pellicle frame was fixed onto the photomask stage only by the mechanical clamp.

Further, an EUV light having a wavelength of 13.5 nm was intermittently projected onto the photomask unit for three minutes in total and the reflection ratio of the photomask was measured after the irradiation with the EUV light. The thus measured reflection ratio of the photomask was compared with the reflection ratio of the photomask before the irradiation with the EUV light. As a result, the reduction in reflection ratio of the photomask was not observed.

### WORKING EXAMPLE NO. 3

A square shaped photomask substrate whose one side length was 152 mm and thickness was 6 mm and which was made of quartz was prepared and a chromium film was evaporated on the one surface of the photomask substrate and the other surface of the photomask substrate was fixed onto a photomask stage by an electrostatic chuck.

Then, a pellicle frame whose inner frame length was 160 mm, outer frame length was 166 mm and wall thickness was 3 mm and which was made of aluminum was prepared and the pellicle frame was fixed by a silicone agglutinant agent onto the photomask stage at a region outside of a region of the photomask stage onto which the photomask substrate, thereby fabricating a photomask unit.

Next, in order to simulate the behavior of the photomask unit when it would be subjected to a high speed scanning operation in an actual manufacturing line, the photomask stage was vibrated for ten minutes so that acceleration of about 5 G was applied to the photomask stage. As a result, the displacement of the pellicle frame from its initial position was not observed although the pellicle frame was fixed onto the photomask stage only by the silicone agglutinant.

Further, an EUV light having a wavelength of 13.5 nm was intermittently projected onto the photomask unit for three minutes in total and the reflection ratio of the photomask was measured after the irradiation with the EUV light. The thus measured reflection ratio of the photomask was compared with the reflection ratio of the photomask before the irradiation with the EUV light. As a result, the reduction in reflection ratio of the photomask was not observed.

### COMPARATIVE EXAMPLE

A square shaped photomask substrate whose one side length was 152 mm and thickness was 6 mm and which was made of quartz was prepared and a chromium film was evaporated on the one surface of the photomask substrate and the other surface of the photomask substrate was fixed onto a photomask stage by an electrostatic chuck.

Then, a pellicle frame whose inner frame length was 143 mm, outer frame length was 149 mm and wall thickness was 3 mm and which was made of aluminum was prepared and the pellicle frame was fixed by a silicone agglutinant agent onto the photomask substrate, thereby fabricating a photomask unit.

Next, in order to simulate the behavior of the photomask unit when it would be subjected to a high speed scanning operation in an actual manufacturing line, the photomask stage was vibrated for ten minutes so that acceleration of about 5 G was applied to the photomask stage. As a result, the displacement of the pellicle frame from its initial position was not observed.

Further, an EUV light having a wavelength of 13.5 nm was intermittently projected onto the photomask unit for three minutes in total and the reflection ratio of the photomask was measured after the irradiation with the EUV light. The thus measured reflection ratio of the photomask was compared with the reflection ratio of the photomask before the irradiation with the EUV light. As a result, it was observed that the reflection ratio of the photomask was reduced by about 0.5% by the irradiation with the EUV light. It would be reasonable to understand that this reduction in the reflection ratio of the photomask was caused by outgas generated from the silicone agglutinant agent used for fixing the pellicle frame.

The present invention has thus been shown and described with reference to the preferred embodiments and the working examples. However, it should be noted that the present invention is in no way limited to the details of the described arrangement but changes and modifications may be made without departing from the scope of the appended claims.

For example, the pellicle frame 7 is fixed onto the photomask stage 3 by the electrostatic chuck in the preferred embodiment shown in FIGS. 3 and 4 and the pellicle frame 7 is fixed onto the photomask stage 3 by the mechanical clamp 9 in the preferred embodiment shown in FIGS. 5 and 6. However, it is not absolutely necessary to fix the pellicle frame 7 onto the photomask stage 3 by the electrostatic chuck or the mechanical clamp 9 and the pellicle frame 7 may be fixed onto the photomask stage 3 by an agglutinant agent containing an organic material such as a silicone agglutinant agent. According to the present invention, even in the case of fixing the pellicle frame 7 onto the photomask stage 3 using an agglutinant agent containing an organic material such as a silicone agglutinant agent, since the pellicle frame 7 is fixed onto the photomask stage 3 at a region outside of a region of the photomask stage 3 onto which the photomask 2 is fixed, when the photoresist film of a semiconductor wafer or a liquid crystal display panel mother substrate (not shown) is exposed to an EUV light while keeping an exposure chamber to be vacuum, even if an outgas is generated from the agglutinant agent containing an organic material, it is possible to suppress the adverse effect of the outgas to the minimum.

Further, although the pellicle frame 7 is fixed onto the photomask stage 3 by the mechanical clamp 9 in the preferred embodiment shown in FIGS. 5 and 6, in the case of fixing the pellicle frame 7 onto the photomask stage 3 by a mechanical means, it is not absolutely necessary to fix the pellicle frame 7 onto the photomask stage 3 using the mechanical clamp 9 but the pellicle frame 7 may be fixed onto the photomask stage 3 using other mechanical means such as a thread.

Moreover, in the above described preferred embodiments and Working Examples, although the pellicle frame 7 made of aluminum was used, it is not absolutely necessary to use a pellicle frame 7 made of aluminum but it is possible to use a pellicle frame 7 made of other metal such as stainless steel instead of aluminum. Further, it is not absolutely necessary for a pellicle frame 7 to be made of metal but it is possible to make a pellicle frame 7 of plastics such as polyethylene.

Furthermore, in Working Examples, although the photomask substrate having a square shape and the pellicle frame whose inner frame length was 160 mm, outer frame length was 166 mm having a rectangle shape were used, it is not absolutely necessary for each of the photomask substrates to have a square shape and it is not absolutely necessary for each of the pellicle frames to have a size whose inner frame length is 160 mm, outer frame length is 166 mm rectangle shape. It is possible to use the photomask substrate or the pellicle frames having an arbitrary shape as occasion demands.

What is claimed:

1. A photomask unit comprising a pellicle membrane, a pellicle frame having a frame-like shape onto one surface of which a region of the pellicle membrane in the vicinity of side portions thereof is fixed, a photomask, and a stage onto one surface of which the photomask and the pellicle frame are fixed, wherein
the pellicle frame is fixed onto the stage at a region outside of a region of the stage onto which the photomask is fixed.

2. A photomask unit in accordance with claim 1, wherein the pellicle frame is made of metal.

3. A photomask unit in accordance with claim 1 or 2, wherein the pellicle frame is fixed by an electrostatic chuck onto the one surface of the stage.

4. A photomask unit in accordance with claim 1 or 2, wherein the pellicle frame is fixed by a mechanical means onto the one surface of the stage.

5. A photomask unit in accordance with claim 1 or 2, wherein the pellicle frame is fixed using an agglutinant agent onto the one surface of the stage.

6. A method for fabricating a photomask unit comprising a pellicle membrane, a pellicle frame having a frame-like shape onto one surface of which a region of the pellicle membrane in the vicinity of side portions thereof is attached, a photomask and a stage onto one surface of which the photomask and the pellicle frame are to be fixed;
the method for fabricating a photomask unit comprising steps of fixing the photomask onto the one surface of the stage and fixing the other surface of the pellicle frame onto the one surface of the stage at a region outside of a region of the one surface of the stage onto which the photomask is fixed.

7. A method for fabricating a photomask unit in accordance with claim 6, wherein the pellicle frame is made of metal.

8. A method for fabricating a photomask unit in accordance with claim 6 or 7, wherein the pellicle frame is fixed by an electrostatic chuck onto the one surface of the stage.

9. A method for fabricating a photomask unit in accordance with claim 6 or 7, wherein the pellicle frame is fixed by a mechanical means onto the one surface of the stage.

10. A method for fabricating a photomask unit in accordance with claim 6 or 7, wherein the pellicle frame is fixed by an agglutinant agent onto the one surface of the stage.
